(19) United States
(12) Patent Application Publication
(10) Pub. No.: US 2023/0136126 A1
(43) Pub. Date: May 4, 2023

(54) INK REPLENISHMENT CONTAINER

(71) Applicant: SEIKO EPSON CORPORATION, Tokyo (JP)

(72) Inventors: Tadahiro MIZUTANI, Shiojiri-shi (JP); Yoshihiro KOIZUMI, Shiojiri-shi (JP); Taku ISHIZAWA, Matsumoto-shi (JP); Tadashi WATANABE, Matsumoto-shi (JP)

(73) Assignee: SEIKO EPSON CORPORATION, Tokyo (JP)

(21) Appl. No.: 17/980,159

(22) Filed: Nov. 3, 2022

(30) Foreign Application Priority Data
Nov. 4, 2021 (JP) 2021-180015

(51) Int. Cl. B41J 2/175

(52) U.S. Cl. CPC B41J 2/17523; B41J 2/17513; B41J 2/17556; B41J 2/17596

(57) ABSTRACT

An ink replenishment container includes a container main body, an ink outlet forming section, and a valvehaving elasticity. An exterior of the valve is circular in plan view and has two or more slits that extend from a center toward a circumference so as to be joined at the center, two inclined surfaces toward the slit are formed for each of the slits so as to interpose the slit therebetween like a valley when viewed from the ink outlet side, and when a pressure difference positive in a direction from an inside of the ink replenishment container to an outside thereof acts on inner sides of the two inclined surfaces, the slits are closed, and when a pressure difference positive in a direction from the outside of the ink replenishment container to the inside thereof acts on outer sides of the two inclined surfaces, the slits are opened.

The present application is based on, and claims priority from JP Application Serial Number 2021-180015, filed Nov. 4, 2021, the disclosure of which is hereby incorporated by reference herein in its entirety.

### BACKGROUND

### 1. Technical Field

The present disclosure relates to an ink replenishment container.

### 2. Related Art

Typical examples of ink ejecting apparatuses include ink jet printers that perform printing by ejecting ink from a printing head onto a printing medium, such as a printing sheet. Such ink jet printers include ink replenishment-type printers used with an ink tank that is replenishable with ink. JP-A-2019-51723 discloses an ink replenishment container of the ink replenishment type in which a slit valve is provided in an ink outlet. The ink replenishment container supplies ink when coupled to a needle divided into two flow paths by a partition.

Since ink replenishment containers are used in various postures or various use environments, it is desirable to further improve measures against ink leakage.

### SUMMARY

(1) According to a first aspect of the disclosure, an ink replenishment container for replenishing an ink tank of a printer with ink through a flow path member of the ink tank, the flow path member partitioned into two flow paths by a partition, is provided. The ink replenishment container includes a container main body configured to store ink and an ink outlet forming section that includes a tubular portion including an ink outlet, that includes a valve attached to an inside of the tubular portion and having elasticity, and that is coupled to the container main body. An exterior of the valve is circular in plan view viewed from an ink outlet side in a direction of a central axis of the ink outlet and has two or more slits that include a center and extend from the center toward a circumference so as to be joined at the center, two inclined surfaces toward the slit are formed for each of the slits so as to interpose the slit therebetween like a valley when viewed from the ink outlet side, and when a pressure difference which is positive in a direction from an inside of the ink replenishment container to an outside thereof acts on inner sides of the inclined surfaces, the slits are closed and brought into a closed valve state, and when a pressure difference which is positive in a direction from the outside of the ink replenishment container to the inside thereof acts on outer sides of the inclined surfaces, the slits are opened and brought into an open valve state, and through the flow path member that pushes the valve from the outside of the ink replenishment container to the inside thereof to bring the valve into the open valve state, air in the ink tank is fed into the container main body, and the ink stored in the container main body is supplied to the ink tank.

### BRIEF DESCRIPTION OF THE DRAWINGS

FIG. 1 is a perspective view of a printer of a first embodiment.

FIG. 2 is a perspective view illustrating a state in which an ink tank is replenished with ink by using an ink replenishment container.

FIG. 3 is an exploded perspective view of the ink replenishment container of the first embodiment.

FIG. 4 is a perspective view of the ink replenishment container.

FIG. 5 is a plan view of a valve viewed from a rear end side.

FIG. 6 is a first perspective view of the valve.

FIG. 7 is a second perspective view of the valve.

FIG. 8 is a plan view of the valve attached to a container main body and viewed from an ink outlet side in a direction of a central axis of an ink outlet.

FIG. 9 is a sectional view of the ink replenishment container.

FIG. 10 is a perspective view of the ink tank of the first embodiment.

FIG. 11 is a sectional view illustrating a state in which the ink replenishment container in an inverted posture and the ink tank are apart from each other in an axial direction.

FIG. 12 is a sectional view illustrating a state in which inner surfaces of inclined surfaces of the valve and end portions of a flow path member in a diameter direction are in contact with each other.

FIG. 13 is a sectional view illustrating a state in which the ink replenishment container is attached to the flow path member.

FIG. 14 is a schematic view for describing a shape of a slit of the valve.

FIG. 15 is a sectional view of the ink replenishment container in a state in which a cap is on.

FIG. 16 is a sectional view of the ink replenishment container in a state in which the cap is partially removed.

FIG. 17 is a sectional view of the ink replenishment container in a state in which the cap is completely removed.

FIG. 18 is a schematic view for describing three linear slits extending in a radial direction.

FIG. 19 is a schematic view for describing four linear slits extending in the radial direction.

FIG. 20 is a schematic view for describing a slit formed by a curved portion extending toward a circumference.

### DESCRIPTION OF EXEMPLARY EMBODIMENTS

### A. First Embodiment

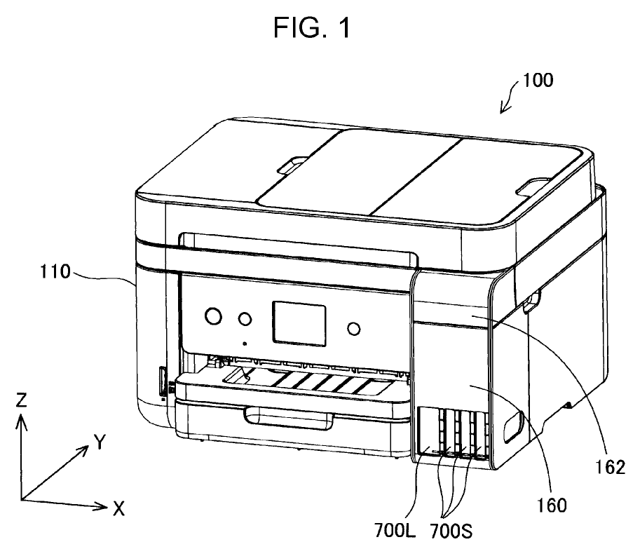

FIG. 1 is a perspective view of a printer 100 of a first embodiment. The printer 100 is an ink jet printer that ejects ink onto a printing medium to perform printing. FIG. 1 illustrates the X-axis, the Y-axis, and the Z-axis, which are orthogonal to each other. The X-axis corresponds to the width direction of the printer 100, the Y-axis corresponds to the depth direction of the printer 100, and the Z-axis corresponds to the height direction of the printer 100. The printer 100 is installed on a horizontal installation surface prescribed by the X-axis direction and the Y-axis direction. Note that “X-axis direction” denotes a concept in which the +X direction and the -X direction are combined. Similarly, “Y-axis direction” denotes a concept in which the +Y direction and the -Y direction are combined, and “Z-axis direction” denotes a concept in which the +Z direction and the -Z direction are combined.

The printer 100 includes a housing 110. A carriage (not illustrated) capable of moving in a main scanning direction (X-axis direction) is provided in the housing 110. A printing head that ejects ink onto a printing medium is provided in the carriage. An ink tank accommodating unit 160 that accommodates a plurality of ink tanks 700S and 700L is provided in one end of the front surface of the housing 110. The ink tank accommodating unit 160 includes a lid 162, which is openable/closable, in the upper portion thereof. Note that the ink tank 700S is a tank having a small capacity, and the ink tank 700L is a tank having a large capacity. However, in the following description, no distinction is made between the ink tank 700S and the ink tank 700L, and the ink tank 700S and the ink tank 700L are each simply referred to as “ink tank 700”. Each of the ink tanks 700 is coupled to the printing head of the carriage via a tube (not illustrated). That is, the ink tank 700 is a stationary ink tank which is not mounted on the carriage of the printer 100. Moreover, each of the ink tanks 700 is an ink tank of an ink replenishment type, which is refilled with ink from an ink replenishment container when a remaining amount of ink becomes small. Note that, although the ink tank 700 is the stationary ink tank in the present embodiment, the ink tank 700 may be an ink tank mounted on the carriage of the printer 100.

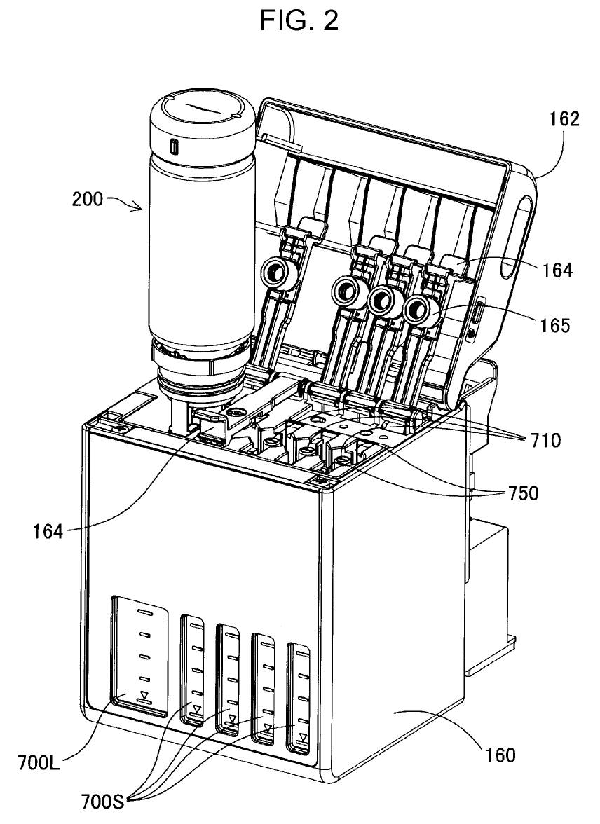

FIG. 2 is a perspective view illustrating a state in which the ink tank 700 is replenished with ink by using an ink replenishment container 200. The front surface of each ink tank 700 is formed from a transparent member, and the remaining amount of ink in each ink tank 700 is viewable from the outside. When the remaining amount of ink becomes small, as illustrated in FIG. 2, it is possible to open the lid 162 and supply ink through a flow path member 710 of the ink tank 700.

The flow path member 710 having a tubular shape and used for replenishing the ink tank 700 with ink is provided on the upper surface of each ink tank 700. The ink tank accommodating unit 160 includes a sealing cap member 164 having a sealing cap 165 used for sealing the tip end of the flow path member 710. In a state in which the ink tank 700 is not replenished with ink, the tip end of the flow path member 710 is sealed by the sealing cap 165 of the sealing cap member 164. When the ink tank 700 is replenished with ink, the sealing cap member 164 is removed from the flow path member 710, a tip end portion of the ink replenishment container 200 is inserted at a position of the flow path member 710, and ink is supplied. Two recess portions 750, into which fitting portions (described below) of the ink replenishment container 200 are fitted, are provided in the periphery of the flow path member 710. The recess portions 750 have shapes which are 180° rotationally symmetric about the flow path member 710.

In the present specification, “ink replenishment” refers to an action of supplying ink to the ink tank 700 to increase the remaining amount of ink. Note that ink replenishment includes an action of filling the empty ink tank 700 with ink at a time of first use of the printer 100 but does not necessarily result in the ink tank 700 being filled with ink.

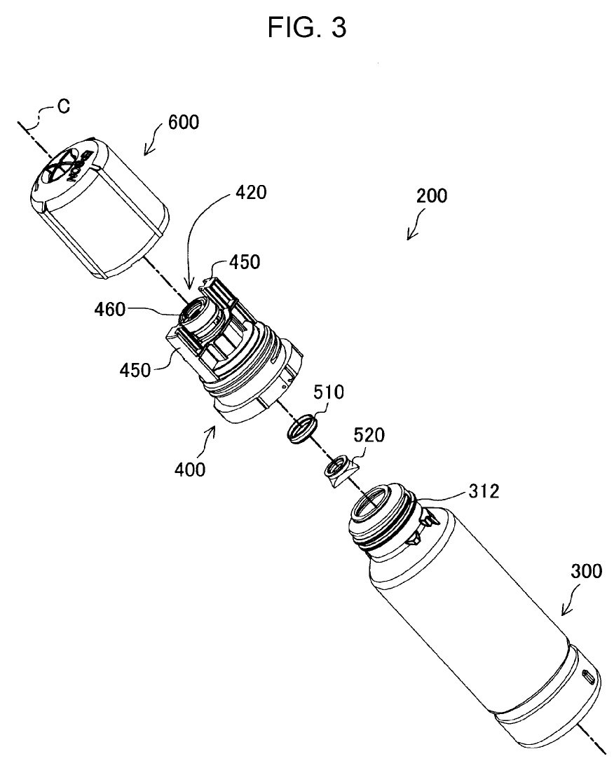

FIG. 3 is an exploded perspective view of the ink replenishment container 200 of the first embodiment. The ink replenishment container 200 includes a container main body 300 that is able to store ink, an ink outlet forming section 400 that forms an ink outlet 460 described later, a ring-like member 510, a valve 520, and a cap 600 that is attached to the ink outlet forming section 400 and that is able to cover the ink outlet 460. The upper end side of the ink replenishment container 200, which is on the cap 600 side, is referred to as “tip end side”, and the lower end side thereof, which is on the container main body 300 side, is referred to as “rear end side”. The container main body 300 is a bottomed cylindrical container having an opening on the tip end side. In a small-diameter portion in the tip end of the container main body 300, an outer thread 312 used for attaching the ink outlet forming section 400 is provided. Note that, in the disclosure, a direction parallel to the central axis C of the ink replenishment container 200 is referred to as “axial direction”, and a direction directed outward from the central axis C is referred to as “diameter direction”. The diameter direction is also referred to as “radial direction”.

The ink outlet 460 is provided in the tip end of the ink outlet forming section 400. The ink outlet forming section 400 is coupled to the container main body 300. The ink outlet forming section 400 includes a tubular portion 420 having the ink outlet 460. The ring-like member 510 and the valve 520 are attached to the inside of the tubular portion 420. Accordingly, the ring-like member 510 and the valve 520 are able to be also regarded as members constituting a portion of the ink outlet forming section 400. When the ink tank 700 is replenished with ink, the flow path member 710 (FIG. 2) of the ink tank 700 is inserted into the ink outlet 460.

The ring-like member 510 has a substantially ring-like shape. The ring-like member 510 has a function of fixing the valve 520 in the tubular portion 420.

The valve 520 has elasticity. The valve 520 is formed as a so-called duckbill valve. The valve 520 is formed of butyl rubber in the present embodiment. Note that the valve 520 is not limited to being formed of butyl rubber and may be formed of any other kind of elastic material, such as silicone rubber, as long as operational effects of the present embodiment are exerted.

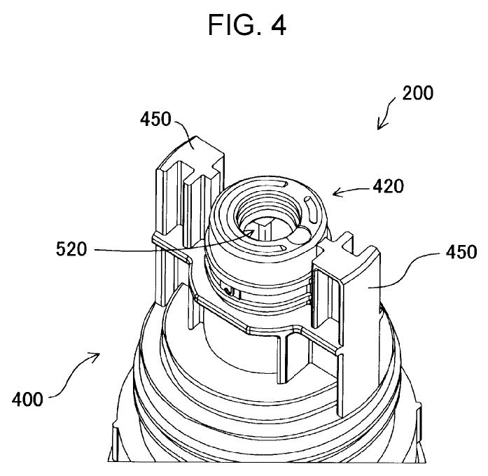

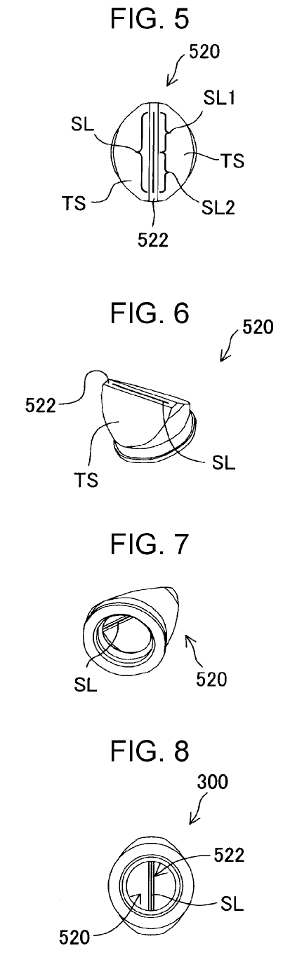

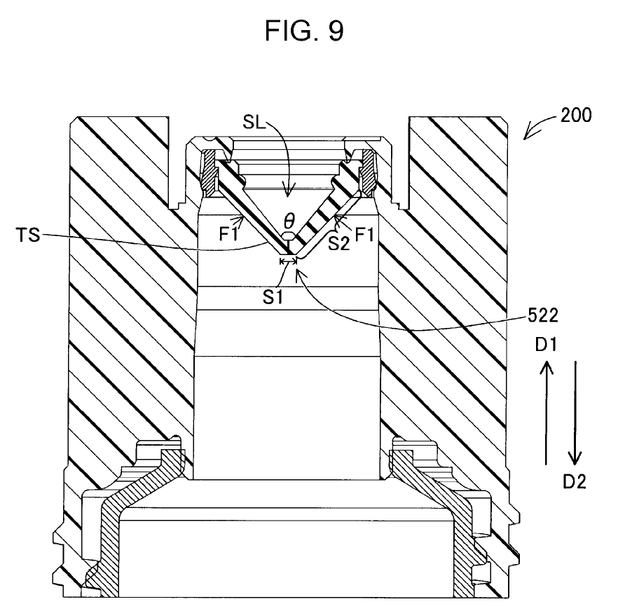

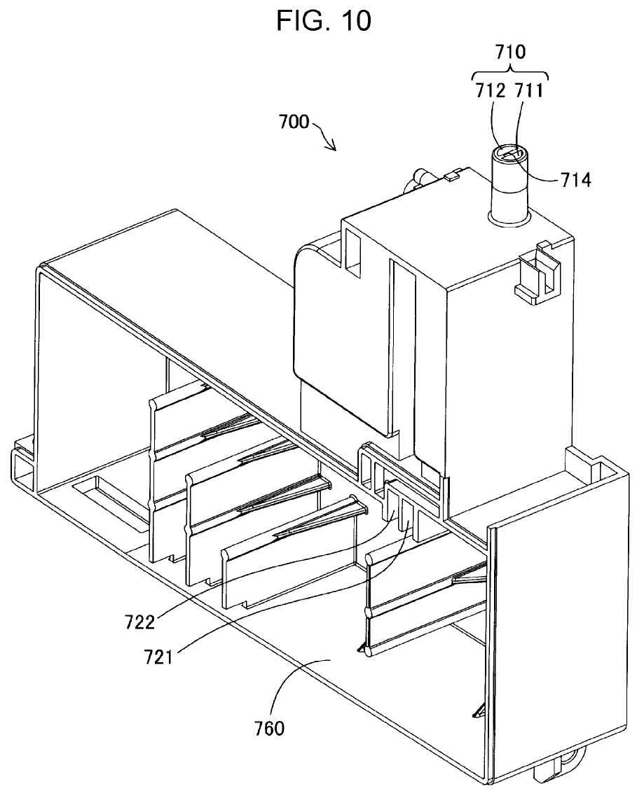

FIG. 4 is a perspective view of the ink replenishment container 200. FIG. 5 is a plan view of the valve 520 viewed from the rear end side. FIG. 6 is a first perspective view of the valve 520. FIG. 7 is a second perspective view of the valve 520. FIG. 8 is a plan view of the valve 520 attached to the container main body 300 and viewed from the ink outlet side in the direction of the central axis of the ink outlet. FIG. 9 is a sectional view of the ink replenishment container 200. Note that FIG. 9 is a sectional view along the central axis. Moreover, for convenience of illustration, FIGS. 4 and 9 each illustrate a portion of the ink replenishment container 200. As illustrated in FIGS. 4 to 9, a slit SL is formed in the valve 520. As illustrated in FIG. 8, an exterior of the valve 520 is circular in plan view. A single linear slit SL in which two slits SL1 and SL2 that include the center of the circular shape and extend from the center toward the circumference are joined at the center is formed in a bottom portion 522 of the valve 520. Here, “circular” has a broad concept including not only perfectly circular but also substantially circular and elliptical.

As illustrated in FIGS. 5, 6, and 9, two inclined surfaces toward the slit SL are formed for each slit in the slits SL of the valve 520 so as to interpose the slit therebetween like a valley when viewed from the ink outlet side and so as to form an angle θ toward the slit. Regarding the valve 520 illustrated in FIGS. 5, 6, and 9, two inclined surfaces interposing the slit SL1 therebetween and two inclined surfaces interposing the slit SL2 therebetween are coupled in the diameter direction and form two inclined surfaces TS interposing the slit SL therebetween. Being formed so as to form an angle θ like a valley refers to being formed such that the angle θ formed between the two inclined surfaces TS is smaller than 180°. Here, as illustrated in FIGS. 5, 6, and 9, the two inclined surfaces TS do not intersect each other and are positioned so as to interpose the bottom portion 522 therebetween. Accordingly, “angle formed between the two inclined surfaces TS” above refers to an angle formed by virtual surfaces obtained by extending the two inclined surfaces TS. The angle θ is 90° in the present embodiment. Note that the angle θ formed by the two inclined surfaces TS is not limited to 90° and may be any angle as long as the operational effects of the present embodiment are exerted. A dimension S1 indicated in FIG. 9 denotes a dimension of the bottom portion 522 in a direction (diameter direction) orthogonal to the axial direction. Moreover, a dimension S2 indicated in FIG. 9 denotes a dimension of an inclined surface TS. Specifically, the dimension S2 denotes a dimension along the inclined surface TS. In the present embodiment, the dimension S2 is ten times the dimension S1. Note that the dimension S2 is not limited to being ten times the dimension S1 and may be equal to or more than ten times the dimension S1 as long as the operational effects of the present embodiment are exerted. When a force F1 generated by pressure which is positive in a direction from the inside of the ink replenishment container 200 to the outside thereof acts on the inner sides of the two inclined surfaces TS in FIG. 9, the slit SL is closed and brought into a closed valve state. That is, when a pressure difference which is positive in the direction from the inside of the ink replenishment container to the outside thereof acts on the inner sides of the inclined surfaces TS, the slit SL is closed and brought into the closed valve state. When the posture of the ink replenishment container 200 is inverted, the weight of ink in the container main body 300 generates the force F1. Hereinafter, a posture of the inverted ink replenishment container 200 in which the ink outlet faces downward is referred to as “inverted posture”.

Parts of the ink replenishment container 200 other than the valve 520 may be formed of thermoplastic resin, such as polyethylene or polypropylene.

As illustrated in FIG. 3, two fitting portions 450 are provided in the periphery of the ink outlet 460. The fitting portions 450 are positioning members that position the ink replenishment container 200 by being fitted into the recess portions 750 (FIG. 2) provided in the periphery of the flow path member 710 of the ink tank 700. Positioning refers to at least one of a function of preventing ink from being erroneously injected in such a manner that the ink replenishment container 200 for replenishment with yellow ink is made to be fitted into the recess portions 750 corresponding to the ink tank 700 for storing yellow ink and the ink replenishment container 200 for replenishment with ink of a different color, such as magenta ink or cyan ink, is made to be unable to be fitted thereinto and a function of stabilizing an ink injection posture of the ink replenishment container as described below. The function of preventing ink from being erroneously injected is not limited to being used for preventing injection of ink of an incorrect color and may also be a function of preventing erroneous injection of dye ink and pigment ink of, for example, black ink. In the first embodiment, the two fitting portions 450 have shapes which are 180° rotationally symmetric about the central axis C of the ink replenishment container 200. Similarly, the recess portions 750 provided in the periphery of the flow path member 710 of the ink tank 700 also have the shapes which are 180° rotationally symmetric about the flow path member 710. At a time of ink replenishment, when the fitting portions 450 of the ink replenishment container 200 are fitted into the recess portions 750 in the periphery of the flow path member 710 of the ink tank 700, the orientation of the ink replenishment container 200 is restricted to two orientations which are 180° rotationally symmetric. As a result, it is possible to retain the ink replenishment container 200 to be in a stable posture at the time of ink replenishment. However, the fitting portions 450 may be omitted.

FIG. 10 is a perspective view of the ink tank 700 of the first embodiment. The flow path member 710 of the ink tank 700 protrudes upward from the ink tank 700. The flow path member 710 includes two flow paths 711 and 712. The two flow paths 711 and 712 are partitioned by a partition wall 714. In the first embodiment, the tip end surface of the flow path member 710 is planar, and the two flow paths 711 and 712 each open in the tip end surface of the flow path member 710. Moreover, a portion of the tip end surface of the flow path member 710 corresponds to an end portion of the partition wall 714. At the time of ink replenishment, the fitting portions 450 of the ink replenishment container 200 are fitted into the recess portions 750 in the periphery of the flow path member 710 of the ink tank 700, and the ink replenishment container 200 is positioned in a circumferential direction. The two flow paths 711 and 712 thereby communicate with two in-tank flow paths 721 and 722 protruding in an ink storing chamber 760 provided in a lower portion relative to the flow paths 711 and 712, respectively. The lower ends of the in-tank flow paths 721 and 722 extend to positions lower than the top wall of the ink storing chamber 760. This is because, when the ink tank 700 is replenished with ink from the ink replenishment container 200, an operation of ink replenishment is facilitated since gas-liquid exchange stops when a liquid level in the ink storing chamber 760 reaches the lower ends of the in-tank flow paths 721 and 722 and, in accordance therewith, ink replenishment also stops.

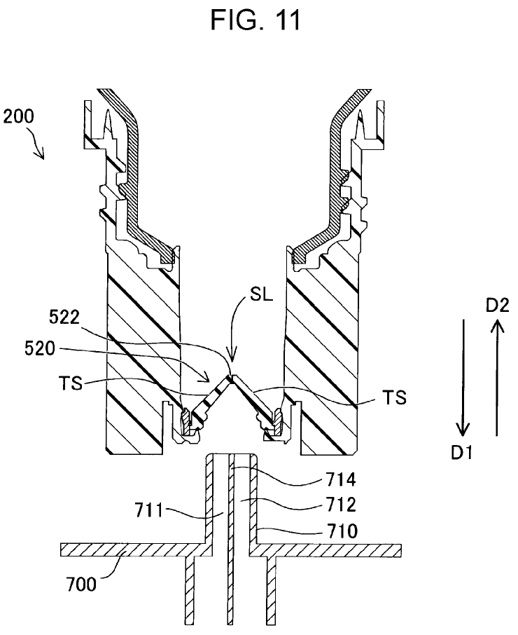

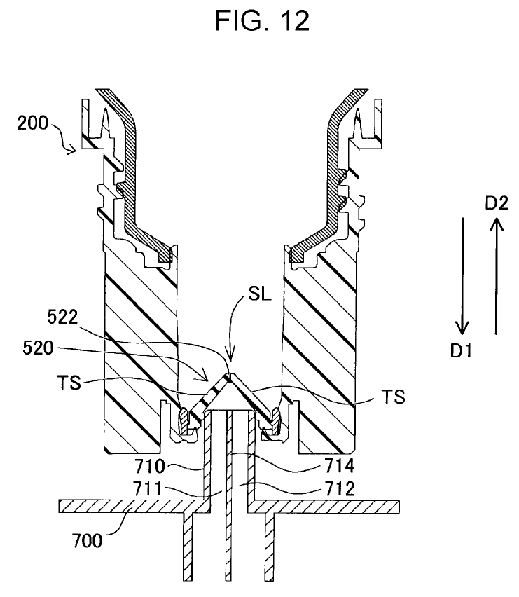

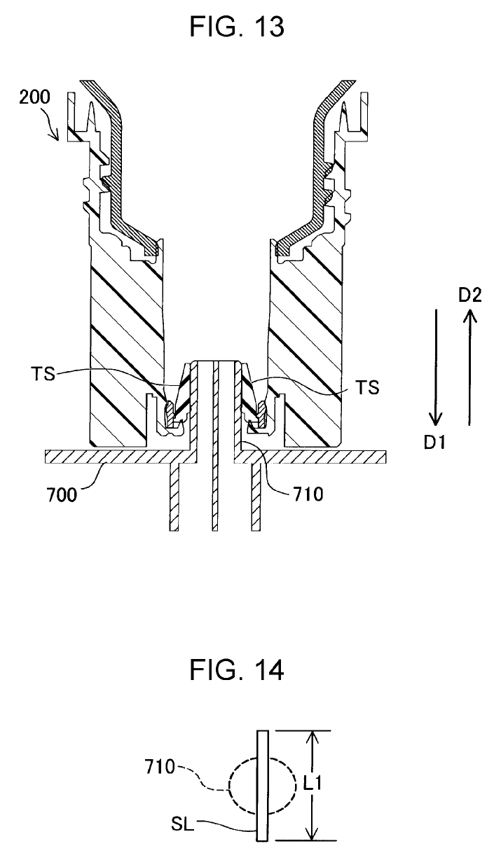

FIG. 11 is a sectional view illustrating a state in which the ink replenishment container 200 in the inverted posture and the ink tank 700 are apart from each other in the axial direction. FIG. 12 is a sectional view illustrating a state in which the inner surfaces of the inclined surfaces TS of the valve 520 and the end portions of the flow path member 710 in the diameter direction are in contact with each other. FIG. 13 is a sectional view illustrating a state in which the ink replenishment container 200 is attached to the flow path member 710. As illustrated in FIGS. 11 to 13, at the time of ink replenishment, the ink replenishment container 200 is caused to be in the inverted posture. A direction from the rear end of the ink replenishment container 200 to the tip end thereof is indicated as a tip end side direction D1 and is a direction in which the ink replenishment container 200 is attached to the flow path member 710. Moreover, a direction from the tip end of the ink replenishment container 200 to the rear end thereof is indicated as a rear end side direction D2 and is a direction in which the ink replenishment container 200 is detached from the flow path member 710. Note that, in FIGS. 11 to 13, only a portion of the ink replenishment container 200 and a portion of the ink tank 700 are illustrated.

In the positional relationship between the ink replenishment container 200 and the flow path member 710 as illustrated in FIGS. 11 and 12, the slit SL is closed and is in the closed valve state. When the flow path member 710 pushes the outer sides of the two inclined surfaces TS as illustrated in FIG. 13 and the slit SL is pressed and opened against the force F1 illustrated in FIG. 9, the slit SL is brought into an open valve state. That is, when the flow path member 710 pushes the outer sides of the inclined surfaces TS, a pressure difference which is positive in a direction from the outside of the ink replenishment container 200 to the inside thereof acts on the outer sides of the inclined surfaces TS, and the slit SL is opened and brought into the open valve state of the valve 520. In the open valve state, air in the ink tank 700 is fed into the container main body 300 through the flow path member 710 inserted into the slit SL, and ink stored in the container main body 300 is supplied to the ink tank 700. In the positional relationship between the ink replenishment container 200 in the inverted posture and the flow path member 710 as illustrated in FIGS. 11 and 12, the slit SL is in the closed valve state due to the above-described force F1 illustrated in FIG. 9. It is thus possible to reduce the possibility of ink leakage from the ink outlet.

FIG. 14 is a schematic view for describing the shape of the slit SL of the valve 520. In the present embodiment, the valve 520 is formed such that the perimeter sum of all the slits SL is equal to the perimeter of the flow path member 710. The perimeter of the slit SL in FIG. 14 is approximately 2 × L1 and equal to the perimeter of the flow path member 710, which is indicated by a broken line. Accordingly, the slit SL is suppressed from being excessively stretched and is readily restored, and it is possible to suppress seams of the slit SL from deviating when the ink replenishment container 200 is removed from the flow path member 710. Accordingly, the slit SL retains excellent sealing performance, thus making it possible to suppress ink from being ejected. Moreover, when the flow path member 710 is inserted into the slit SL, excellent sealability between the valve 520 and the flow path member 710 is also retained, and ink is suppressed from leaking from a gap between the valve 520 and the flow path member 710. Note that, although the valve 520 is formed such that the perimeter sum of the slits SL is equal to the perimeter of the flow path member 710 as described above, the term “equal” here has a board concept including not only a configuration in which the perimeter sum of the slits SL is equal to the perimeter of the flow path member 710 but also a configuration in which the perimeter sum of the slits SL is different from the perimeter of the flow path member 710 within a range of ±10%.

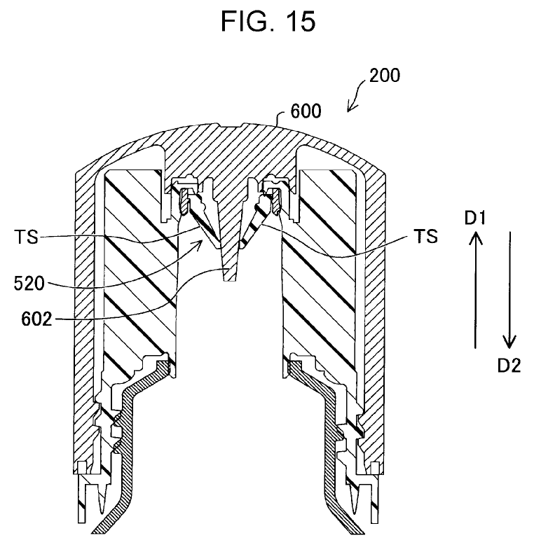

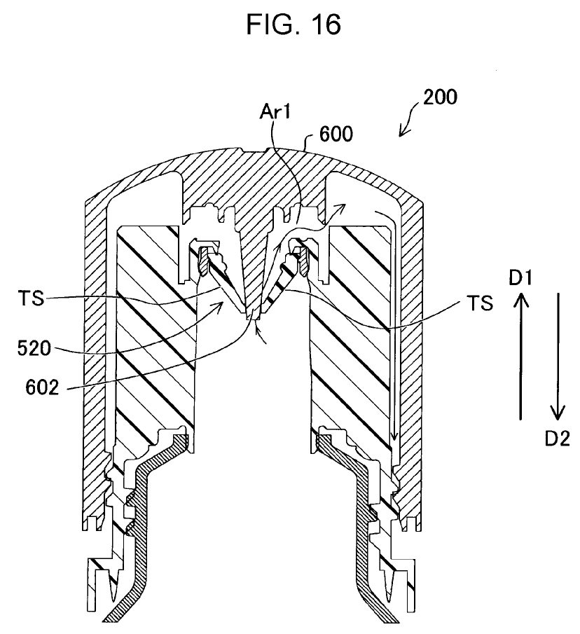

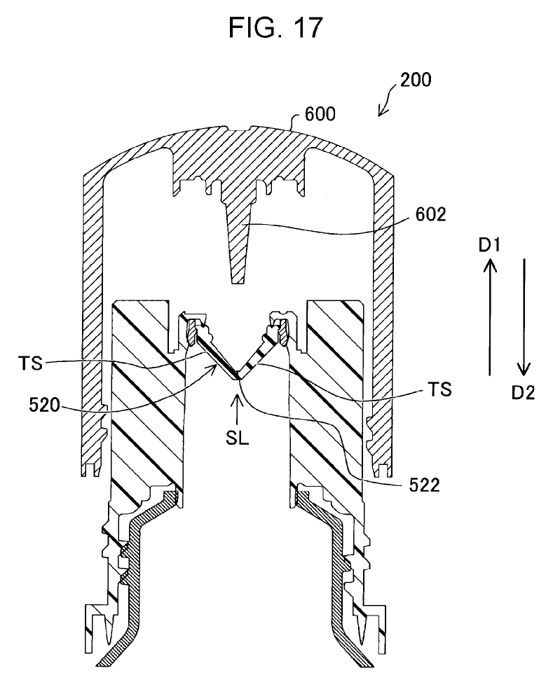

FIG. 15 is a sectional view of the ink replenishment container 200 in a state in which the cap 600 is on. FIG. 16 is a sectional view of the ink replenishment container 200 in a state in which the cap 600 is partially removed. FIG. 17 is a sectional view of the ink replenishment container 200 in a state in which the cap 600 is completely removed. As illustrated in FIG. 15, the cap 600 includes a protrusion 602 extending in the axial direction. In the state in which the cap 600 is on, the protrusion 602 pushes the valve 520 in the rear end side direction D2 and brings the valve 520 into the open valve state. At this time, a screw thread of the inner wall of the cap 600 and a screw thread of the outer wall of the ink outlet forming section 400 engage each other. As illustrated in FIG. 16, removing the cap 600 in the tip end side direction D1 enables air to move through a slight gap between the valve 520 and the protrusion 602 as indicated by an arrow. Specifically, when the cap 600 in the on state as illustrated in FIG. 15 is removed as illustrated in FIG. 16, air in the container main body 300 moves in the tip end side direction D1 through the slight gap between the valve 520 and the protrusion 602 and reaches a space Ar1. The space Ar1 is a space demarcated by the inner wall of the cap 600, which includes an outer peripheral surface of a base portion of the protrusion 602, and the outer wall surfaces of the ink outlet forming section 400 and the valve 520 on the tip end side. The space Ar1 is closed by engaging portions of the screw thread of the inner wall of the cap 600 and the screw thread of the outer wall of the ink outlet forming section 400 and therefore does not communicate with the outside. Accordingly, at this time, air which has moved into the space Ar1 is not discharged to the outside. When the cap 600 is completely removed, as illustrated in FIG. 17, the protrusion 602 which has pressed the valve 520 moves in the tip end side direction D1, and the slit SL is brought into the closed valve state. Accordingly, in this state, air in the container main body 300 does not leak from the valve 520 to the outside. On the other hand, air which has leaked to the space Ar1 in the state of FIG. 16 is discharged to the outside since the threaded engagement between the screw thread of the inner wall of the cap 600 and the screw thread of the outer wall of the ink outlet forming section 400 is terminated. In an instance in which internal pressure of the ink replenishment container 200 is increased due to a change in temperature or a change in ambient pressure, since movement of air illustrated in FIG. 16 enables the internal pressure to be released when the cap 600 in the on state is removed, it is possible to prevent ink from being ejected.

According to the ink replenishment container 200 of the aforementioned first embodiment, the exterior of the valve 520 is circular in plan view viewed from the ink outlet side in the direction of the central axis of the ink outlet and has the slit SL, that is, the two slits SL1 and SL2, which includes the center and extends from the center toward the circumference. Moreover, the valve 520 is a duckbill valve, and two inclined surfaces TS (precisely, inclined surfaces corresponding to half the inclined surfaces TS) are formed for each of the two slits SL1 and SL2 constituting the slit SL so as to interpose the slit therebetween when viewed from the ink outlet side and so as to form an angle like a valley toward the slit. When a pressure difference which is positive in the direction from the inside of the ink replenishment container 200 to the outside thereof acts on the inner sides of the respective inclined surfaces, that is, the inclined surfaces TS, the slit SL is closed and brought into the closed valve state. Moreover, when a pressure difference which is positive in the direction from the outside of the ink replenishment container 200 to the inside thereof acts on the outer sides of the inclined surfaces TS, the slit SL is opened and brought into the open valve state. That is, when the flow path member 710 pushes the outer sides of the inclined surfaces TS and the slit SL is pressed and opened, the slit SL is brought into the open valve state. In the open valve state, air in the ink tank 700 is fed into the container main body 300 through the flow path member 710 inserted into the slit SL, and ink stored in the container main body 300 is supplied to the ink tank 700. It is thus possible to reduce the possibility of ink leakage from the ink outlet when the ink replenishment container 200 is in the inverted posture in which the ink outlet faces downward. Note that, in the first embodiment, in the valve 520, the single slit SL in which the slit SL1 and the slit SL2 are joined is formed, and the two inclined surfaces for the slit SL1 and the two inclined surfaces for the slit SL2 are integrally formed so as to be continuous. Accordingly, it is also possible to consider that the two inclined surfaces TS are formed for the single slit SL.

Moreover, the perimeter sum of the slits SL of the valve 520 is equal to the perimeter of the flow path member 710. Accordingly, the slit SL is suppressed from being excessively stretched and is readily restored, and it is possible to suppress the seams of the slit SL from deviating when the ink replenishment container 200 is removed from the flow path member 710. Accordingly, the slit SL retains the excellent sealing performance, thus making it possible to suppress ink from being ejected. Moreover, when the flow path member 710 is inserted into the slit SL, the excellent sealability between the valve 520 and the flow path member 710 is also retained, and ink is suppressed from leaking from a gap between the valve 520 and the flow path member 710.

Furthermore, the ink replenishment container 200 includes the cap 600 that is able to cover the ink outlet. The cap 600 includes the protrusion 602 that, in the state in which the cap 600 is on, pushes the valve 520 and brings the valve 520 into the open valve state. Accordingly, in the instance in which the internal pressure of the ink replenishment container 200 is increased due to a change in temperature or a change in ambient pressure, the internal pressure is released when the cap 600 in the on state is removed, and it is thus possible to prevent ink from being ejected.

The term “partition wall 714” in the first embodiment corresponds to “partition” in the disclosure.

### B. Other Embodiments

### B-1. Other Embodiment 1

In the ink replenishment container 200 of the aforementioned first embodiment, the valve 520 is formed such that the perimeter sum of the slits SL is equal to the perimeter of the flow path member 710, but the disclosure is not limited thereto. The valve 520 may be formed such that the perimeter sum of the slits SL is larger than the perimeter of the flow path member 710.

### B-2. Other Embodiment 2

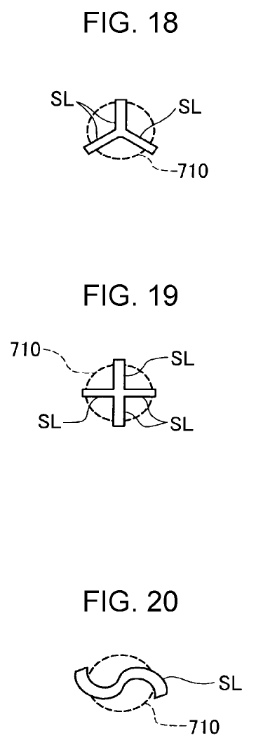

Although the valve 520 includes the slit SL in which the two slits SL1 and SL2 extending from the center toward the circumference are joined and which is linear in the diameter direction in the aforementioned first embodiment, the valve 520 may include three or more slits extending from the center toward the circumference. FIG. 18 is a schematic view for describing three linear slits SL extending from the center toward the circumference in the radial direction. FIG. 19 is a schematic view for describing four linear slits SL extending from the center toward the circumference in the radial direction. As illustrated in FIGS. 18 and 19, in the configuration in which three or more linear slits SL extending from the center of the valve 520 toward the circumference in the radial direction are provided, it is possible in the closed valve state to reduce the slits SL in dimension in the radial direction to ensure the same perimeter, compared with the configuration in the first embodiment that provides the single linear slit SL in which the two slits of the slits SL1 and SL2 extending from the center toward the circumference in the radial direction are joined in the diameter direction. Accordingly, the valve 520 and, furthermore, the tubular portion 420 are readily reduced in size in the radial direction.

### B-3. Other Embodiment 3

Although the valve 520 includes the linear slit in the aforementioned first embodiment, the disclosure is not limited thereto. FIG. 20 is a schematic view for describing the slit SL that includes a curved portion extending from the center toward the circumference. As illustrated in FIG. 20, two slits SL formed by a curved portion extending from the center of the valve 520 toward the circumference in a curved manner in the closed valve state may be provided. Note that the number of slits SL formed by a curved portion extending from the center of the valve 520 toward the circumference in a curved manner in the closed valve state is not limited to two and may be three or more. In the configuration in which the slits SL formed by a curved portion as illustrated in FIG. 20 are provided, it is possible to reduce the slits SL in size in the radial direction to ensure the same perimeter, compared with the configuration in which the linear slit SL is provided as in the first embodiment. It is thus possible to suppress the valve 520 from increasing in size in the radial direction. Accordingly, the valve 520 and, furthermore, the tubular portion 420 are readily reduced in size in the radial direction. Note that, although the slits SL are formed by only the curved portion extending from the center of the valve 520 toward the circumference in the curved manner in FIG. 20, when attention is paid to the single slit SL, a portion of the slit SL may be linear, and the rest may be curved.

### B-4. Other Embodiment 4

Although the ink replenishment container 200 includes the cap 600 in the aforementioned first embodiment, the cap 600 is not necessarily provided.

### B-5. Other Embodiment 5

Although the ink replenishment container 200 includes the bottom portion 522 in the aforementioned first embodiment, the bottom portion 522 is not necessarily provided. The valve 520 in the sectional view as illustrated in FIG. 9 may have a V-shaped configuration in which two inclined surfaces TS extending from the slit SL are formed.

### C. Other Aspects

The disclosure is not limited to the embodiments described above and may be implemented in various configurations within a range not departing from the gist of the disclosure. To address some or all of the above-described problems or to achieve some or all of the above-described effects, for example, technical features in the embodiments corresponding to technical features in the aspects described below can be replaced or combined as appropriate. Moreover, the technical features can be deleted as appropriate unless the technical features are described as essential in the present specification.
(1) According to a first aspect of the disclosure, an ink replenishment container for replenishing an ink tank of a printer with ink through a flow path member of the ink tank, the flow path member partitioned into two flow paths by a partition, is provided. The ink replenishment container includes a container main body configured to store ink and an ink outlet forming section that includes a tubular portion including an ink outlet, that includes a valve attached to an inside of the tubular portion and having elasticity, and that is coupled to the container main body. An exterior of the valve is circular in plan view viewed from an ink outlet side in a direction of a central axis of the ink outlet and has two or more slits that include a center and extend from the center toward a circumference so as to be joined at the center, two inclined surfaces toward the slit are formed for each of the slits so as to interpose the slit therebetween like a valley when viewed from the ink outlet side, and when a pressure difference which is positive in a direction from an inside of the ink replenishment container to an outside thereof acts on inner sides of the inclined surfaces, the slits are closed and brought into a closed valve state, and when a pressure difference which is positive in a direction from the outside of the ink replenishment container to the inside thereof acts on outer sides of the inclined surfaces, the slits are opened and brought into an open valve state, and through the flow path member that pushes the valve from the outside of the ink replenishment container to the inside thereof to bring the valve into the open valve state, air in the ink tank is fed into the container main body, and the ink stored in the container main body is supplied to the ink tank. According to this aspect, when the ink replenishment container is in an inverted posture in which the ink outlet faces downward, a force generated due to a positive pressure difference acts on the inner sides of the inclined surfaces, and the valve is brought into the closed valve state, thus making it possible to reduce the possibility of ink leakage from the ink outlet when the ink replenishment container is in the inverted posture. Moreover, when the pressure in the ink replenishment container is increased due to an environmental change such as a change in temperature, ink may be ejected, but such an occurrence of ink ejection is able to be reduced.
(2) In the aforementioned aspect, the valve may be a duckbill valve. According to this aspect, it is possible to reduce the possibility of ink leakage from the ink outlet when the ink replenishment container is in the inverted posture in which the ink outlet faces downward.
(3) In the aforementioned aspects, the valve may be formed such that a perimeter sum of all the slits is equal to or larger than a perimeter of the flow path member. According to this aspect, the slits are suppressed from being excessively stretched at a time of ink replenishment and are readily restored, and it is possible to suppress seams of the slits from deviating when the ink replenishment container is removed from the flow path member. Accordingly, the slits retain excellent sealing performance, thus making it possible to suppress ink from being ejected. Moreover, when the flow path member is inserted into the slits, excellent sealability between the valve and the flow path member is also retained, and ink is suppressed from leaking from a gap between the valve and the flow path member.
(4) In the aforementioned aspects, the valve may include three or more slits in the closed valve state. According to this aspect, when the number of slits increases, it is possible to reduce the slits in dimension in a radial direction to ensure a desired perimeter of the slits. Accordingly, the valve and, furthermore, the tubular portion are readily reduced in size in the radial direction.
(5) In the aforementioned aspects, the valve may include the slits that include a curved portion extending from the center of the valve to the circumference in a curved manner in the closed valve state. According to this aspect, compared with an instance of linear slits, the slits are readily reduced in size in the radial direction to ensure a desired perimeter of the slits. Accordingly, the valve and, furthermore, the tubular portion are readily reduced in size in the radial direction.
(6) In the aforementioned aspects, a cap configured to cover the ink outlet may be further included, and the cap may include a protrusion that pushes, in a state in which the cap is on, the valve and brings the valve into the open valve state. According to this aspect, in an instance in which internal pressure of the ink replenishment container is increased due to a change in temperature or a change in ambient pressure, the internal pressure is released when the cap in the on state is removed, and it is thus possible to suppress ink from being ejected.

The disclosure is able to be implemented in an aspect of a manufacturing method of an ink replenishment container and the like in addition to the aforementioned aspects.

What is claimed is:

1. An ink replenishment container for replenishing an ink tank of a printer with ink through a flow path member of the ink tank, the flow path member partitioned into two flow paths by a partition, the ink replenishment container comprising:
a container main body configured to store ink; and
an ink outlet forming section that includes a tubular portion including an ink outlet, that includes a valve attached to an inside of the tubular portion and having elasticity, and that is coupled to the container main body, wherein
an exterior of the valve is circular in plan view viewed from an ink outlet side in a direction of a central axis of the ink outlet and has two or more slits that include a center and extend from the center toward a circumference so as to be joined at the center, two inclined surfaces toward the slit are formed for each of the slits so as to interpose the slit therebetween like a valley when viewed from the ink outlet side, and when a pressure difference which is positive in a direction from an inside of the ink replenishment container to an outside thereof acts on inner sides of the inclined surfaces, the slits are closed and brought into a closed valve state, and when a pressure difference which is positive in a direction from the outside of the ink replenishment container to the inside thereof acts on outer sides of the inclined surfaces, the slits are opened and brought into an open valve state, and
through the flow path member that pushes the valve from the outside of the ink replenishment container to the inside thereof to bring the valve into the open valve state, air in the ink tank is fed into the container main body, and the ink stored in the container main body is supplied to the ink tank.

2. The ink replenishment container according to claim 1, wherein the valve is a duckbill valve.

3. The ink replenishment container according to claim 1, wherein the valve is formed such that a perimeter sum of all the slits is equal to or larger than a perimeter of the flow path member.

4. The ink replenishment container according to claim 1, wherein
the valve includes three or more slits in the closed valve state.

5. The ink replenishment container according to claim 1, wherein
the valve includes the slits that include a curved portion extending from the center of the valve toward the circumference in a curved manner in the closed valve state.

6. The ink replenishment container according to claim 1, further comprising
a cap configured to cover the ink outlet, wherein
the cap includes a protrusion that pushes, in a state in which the cap is on, the valve and brings the valve into the open valve state.
